(19) United States
(12) Patent Application Publication
(10) Pub. No.: US 2026/0153360 A1
(43) Pub. Date: Jun. 4, 2026

(54) ANGLE DISPLACEMENT SENSING DEVICE AND MEASUREMENT SYSTEM

(71) Applicant: DEFOND ELECTECH CO., LTD., Dongguan City (CN)

(72) Inventors: Cheng Chen Nieh, Dongguan City (CN); Chiu Keung Loong, Dongguan City (CN); Kin Yu Wong, Dongguan City (CN); Lap Yi Law, Dongguan City (CN); Yiu Cho Yuen, Dongguan City (CN); Wei Hai Pan, Dongguan City (CN); Lian Chuan Lin, Dongguan City (CN)

(21) Appl. No.: 19/233,318

(22) Filed: Jun. 10, 2025

(30) Foreign Application Priority Data
Dec. 4, 2024 (CN) 2024229903477

(51) Int. Cl. G01D 5/14; G01D 11/24

(52) U.S. Cl. CPC G01D 5/145; G01D 11/245

(57) ABSTRACT

The present disclosure provides an angle displacement sensing device and a measurement system, relating to the technical field of measurement, specifically. The angle displacement sensing device includes a main housing body, an induction circuit board, and a rotor assembly; the main housing body is provided with a rotor assembly accommodating cavity, and the induction circuit board is arranged inside the main housing body; the rotor assembly includes a rotor body and a magnet, the rotor body is rotatably mounted in the rotor assembly accommodating cavity, the magnet is arranged between the rotor body and the induction circuit board, and the magnet is fixedly mounted at one end of the rotor body. The angle displacement sensing device can achieve the technical effects of simplifying design and reducing costs.

### CROSS-REFERENCE TO RELATED APPLICATION

The present disclosure claims the priority to the Chinese patent application with the filing No. 2024229903477 filed with the Chinese Patent Office on Dec. 4, 2024, and entitled “ANGLE DISPLACEMENT SENSING DEVICE AND MEASUREMENT SYSTEM”, the contents of which are hereby incorporated by reference in their entirety.

### TECHNICAL FIELD

The present disclosure relates to the technical field of measurement, and specifically, to an angle displacement sensing device and a measurement system.

### BACKGROUND ART

The angle displacement sensor, also known as the angular displacement sensor, is a type of displacement sensor. It adopts a contact or non-contact patent design and, compared to other traditional angle displacement measurement instruments such as synchro resolvers and potentiometers, effectively improves long-term reliability. Its unique design ensures measurement accuracy without using easily worn moving parts such as slip rings, blades, contact sliders, or electric brushes.

Generally, existing angle displacement sensors adopt relatively complex external designs for small-angle measurements, with low IP protection ratings, making them unsuitable for harsh environments. Due to the split design, they often have low measurement accuracy, prolonged debugging cycles, and high costs.

### SUMMARY

The objective of the present disclosure is to provide an angle displacement sensing device and a measurement system, capable of achieving the technical effects of simplifying design and reducing costs.

In a first aspect, the present disclosure provides an angle displacement sensing device including a main housing body, an induction circuit board, and a rotor assembly.

The main housing body is provided with a rotor assembly accommodating cavity, and the induction circuit board is arranged inside the main housing body.

The rotor assembly includes a rotor body and a magnet, the rotor body is rotatably mounted in the rotor assembly accommodating cavity, the magnet is arranged between the rotor body and the induction circuit board, and the magnet is fixedly mounted at one end of the rotor body.

In the above implementation process, the angle displacement sensing device provides a rotor assembly accommodating cavity on the main housing body, which directly mounts the rotor body in a rotatable manner within the rotor assembly accommodating cavity. The matching and mounting method between the rotor body and the rotor assembly accommodating cavity is simple and convenient. Additionally, the magnet is arranged between the rotor body and the induction circuit board, and the magnet is fixedly mounted at the end of the rotor body near the induction circuit board. This simplifies the mounting structure and reduces production costs without affecting the measurement accuracy of the rotor assembly. Therefore, the angle displacement sensing device can achieve the technical effects of simplifying design and reducing costs.

Further, the rotor assembly includes an elastic component, one end of the elastic component is fixedly connected to the rotor assembly accommodating cavity, and another end of the elastic component is fixedly connected to the rotor body.

In the above implementation process, during the rotation of the rotor body, the elastic component switches between its natural state and stretched state, and the rotor body can return to its initial position under the action of the elastic component.

Further, the elastic component is a spring mechanism, the spring mechanism is sleeved on an outer side of the rotor body, one end of the spring mechanism is fixedly connected to the rotor assembly accommodating cavity, and another end of the spring mechanism is fixedly connected to the rotor body.

Further, the spring mechanism is a torsion spring.

In the above implementation process, the two ends of the torsion spring are fixed to the rotor assembly accommodating cavity and the rotor body, respectively. When the rotor body rotates around the center of the torsion spring, the torsion spring generates torque or rotational force, forcing the rotor body to return to its initial position. The torsion spring can store and release angular energy or statically fix the rotor body through rotating force arms around the central axis of the spring.

Further, the main housing body includes a top housing and a bottom housing, the top housing is provided with the rotor assembly accommodating cavity, and the bottom housing is matched and mounted with the top housing. The bottom housing is provided with corresponding metal terminals, and the metal terminals are electrically connected to the induction circuit board.

In the above implementation process, the electrical connection between the metal terminals and the induction circuit board transmits the electrical signals of the induction circuit board to other devices, thereby realizing the output of angle displacement sensing signals.

Further, the top housing or bottom housing is provided with an optional shielding cover. The shielding cover is metal part, which prevent the inference of magnetic field by environment.

Further, the angle displacement sensing device includes a first sealing component, and the bottom housing and the top housing are sealed through the first sealing component.

In the above implementation process, the first sealing component seals the bottom housing and the top housing, thereby preventing the shielding cover and metal terminals from being excessive contact with the air and providing an effective anti-rust effect for the shielding cover and metal terminals.

Further, the rotor assembly includes a rotor cover, wherein the rotor cover is mounted to cover the rotor assembly accommodating cavity.

Further, the rotor assembly includes a second sealing component, wherein the rotor cover is sealed and mounted to the rotor assembly accommodating cavity through the second sealing component.

In the above implementation process, the rotor cover is mounted to cover the rotor assembly accommodating cavity, thereby sealing the rotor assembly within the space of the rotor cover and the rotor assembly accommodating cavity. This protects the magnet and the elastic component from external contact, achieving waterproof, dustproof, and rustproof effects. It effectively extends the service life of the magnet and the elastic component, thereby prolonging the service life of the angle displacement sensing device.

In a second aspect, the present disclosure provides an angle displacement sensing device including a main housing body, an induction circuit board, a metal brush, and a rotor assembly.

The main housing body is provided with a rotor assembly accommodating cavity, and the main housing body is arranged with a metal terminal.

The induction circuit board is arranged inside the main housing body.

The rotor assembly is rotatably arranged in the rotor assembly accommodating cavity of the main housing body, the metal brush is fixedly mounted on the rotor assembly, and the metal brush is electrically connected to the induction circuit board.

In the above implementation process, the angle displacement sensing device is a contact-type angular sensor, distinguishing it from the non-contact-type angular sensor described in the first aspect.

In a third aspect, the present disclosure provides a measurement system, including the angle displacement sensing device as described in any one of the first aspects.

Other features and advantages disclosed in the present disclosure will be explained in the subsequent specification, or some features and advantages may be inferred or self-evident from the specification or can be learned through the implementation of the disclosed technologies above.

In order to make the above objectives, features, and advantages of the present disclosure more obvious and easier to understand, the following better embodiments, together with the attached drawings, are described in detail as follows.

### BRIEF DESCRIPTION OF DRAWINGS

In order to more clearly illustrate the technical solutions of the embodiments of the present disclosure, the following will briefly introduce the drawings used in the embodiments of the present disclosure. It should be understood that the following drawings only show some embodiments of the present disclosure, and therefore it should not be regarded as a limitation on the scope. Those ordinary skilled in the art can also obtain other related drawings based on these drawings without inventive effort.

FIG. 1 is an exploded structural schematic diagram of a first angle displacement sensing device provided in the embodiment of the present disclosure;

FIG. 2 is a first-perspective structural schematic diagram of a first angle displacement sensing device provided in the embodiment of the present disclosure;

FIG. 3 is a second-perspective structural schematic diagram of a first angle displacement sensing device provided in the embodiment of the present disclosure;

FIG. 4 is a sectional structural schematic diagram of a first angle displacement sensing device provided in the embodiment of the present disclosure;

FIG. 5 is an exploded structural schematic diagram of a second angle displacement sensing device provided in the embodiment of the present disclosure; and

FIG. 6 is a sectional structural schematic diagram of a second angle displacement sensing device provided in the embodiment of the present disclosure.

### DETAILED DESCRIPTION OF EMBODIMENTS

Reference numerals: main housing body 100; rotor assembly accommodating cavity 110; top housing 120; bottom housing 130; metal terminal 140; first sealing component 150; shielding cover 160; induction circuit board 200; rotor assembly 300; rotor body 310; magnet 320; elastic component 330; rotor cover 340; metal brushes 400; sealing ring 500.

The technical solutions in the embodiments of the present disclosure will be clearly and completely described below in conjunction with the drawings in the embodiments of the present disclosure. Obviously, the described embodiments are only a part of the embodiments of the present disclosure, and not all of the embodiments. The components of embodiments of the present disclosure which are generally described and illustrated in the drawings herein can be arranged and designed in a variety of different configurations. Accordingly, the following detailed description of the embodiments of the present disclosure provided in the drawings is not intended to limit the scope of the present disclosure for which protection is claimed but merely represents selected embodiments of the present disclosure. Based on the embodiments in the present disclosure, all other embodiments obtained of those of skill in the art of without making inventive efforts are within the scope of protection of the present disclosure.

In the present disclosure, the terms “up”, “down”, “left”, “right”, “front”, “back”, “top”, “bottom”, “inside”, “outside”, “middle”, “vertical”, “horizontal”, “lateral”, “longitudinal”, and other terms indicating orientation or positional relationships are based on the orientation or positional relationships shown in the drawings. These terms are primarily intended to better describe the present disclosure and its embodiments and are not intended to limit the indicated devices, components, or parts to specific orientations or to be constructed and operated in specific orientations.

Furthermore, some of these terms may also imply meanings beyond orientation or positional relationships. For example, the term “upper” may, in certain cases, indicate a dependency relationship or connection relationship. Those skilled in the art can understand the specific meanings of these terms in the present disclosure based on the specific context.

In addition, the terms “mounted”, “set”, “provided with”, “connected”, and “interconnected” should be understood broadly. For example, they may refer to fixed connections, detachable connections, or integral constructions; they may include mechanical connections or point-to-point connections; they may refer to direct connections or indirect connections through intermediaries, or internal communication between two devices, components, or parts. Those of ordinary skill in the art can understand the meanings of the above terms in the present disclosure according to specific situations.

Moreover, the terms “first” and “second” are primarily used to distinguish different devices, components, or parts (which may have the same or different types and structures) and are not intended to indicate or imply the relative importance or quantity of the devices, components, or parts. Unless otherwise indicated, the term “multiple” means two or more.

The embodiments of the present disclosure provide an angle displacement sensing device and a measurement system, which can be applied in the process of measuring angle displacement. The angle displacement sensing device provides a rotor assembly accommodating cavity on the main housing body, which directly mounts the rotor body in a rotatable manner within the rotor assembly accommodating cavity. The matching and mounting method between the rotor body and the rotor assembly accommodating cavity is simple and convenient. Additionally, the magnet is arranged between the rotor body and the induction circuit board, and the magnet is fixedly mounted at the end of the rotor body near the induction circuit board. This simplifies the mounting structure and reduces production costs without affecting the measurement accuracy of the rotor assembly. Therefore, the angle displacement sensing device can achieve the technical effects of simplifying design and reducing costs.

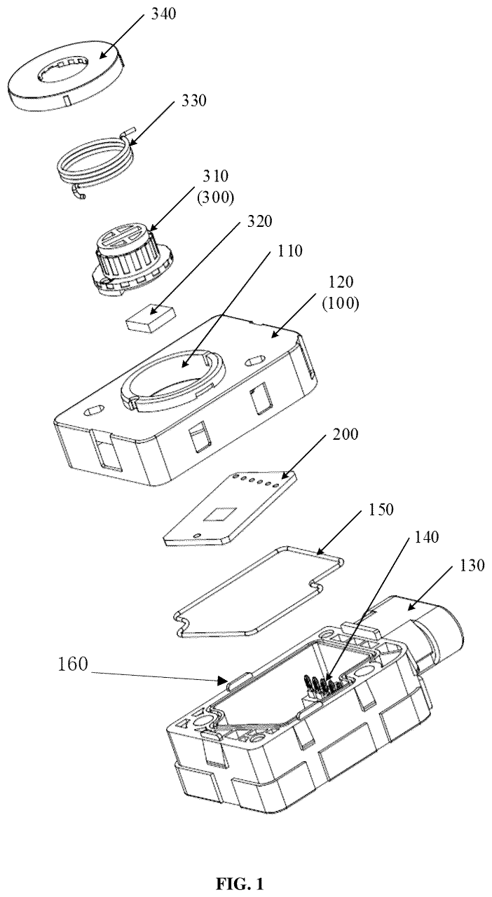

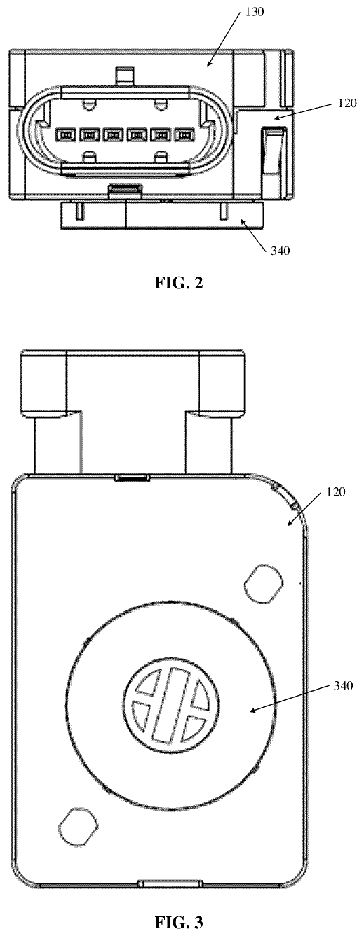

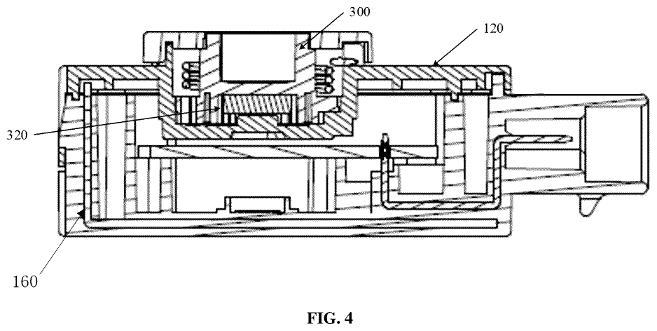

Referring to FIGS. 1 to 4, FIG. 1 is an exploded structural schematic diagram of a first angle displacement sensing device provided in the embodiment of the present disclosure; FIG. 2 is a first perspective structural schematic diagram of a first angle displacement sensing device provided in the embodiment of the present disclosure; FIG. 3 is a second perspective structural schematic diagram of a first angle displacement sensing device provided in the embodiment of the present disclosure; and FIG. 4 is a sectional structural schematic diagram of a first angle displacement sensing device provided in the embodiment of the present disclosure. The angle displacement sensing device includes a main housing body 100, an induction circuit board 200, and a rotor assembly 300.

Exemplarily, the main housing body 100 is provided with a rotor assembly accommodating cavity 110, and the induction circuit board 200 is arranged inside the main housing body 100. The induction circuit board 200 is mounted inside the main housing body 100 to protect the induction circuit board 200 from being corroded or disturbed by water vapor in the external environment.

Exemplarily, the rotor assembly 300 includes a rotor body 310 and a magnet 320, wherein the rotor body 310 is rotatably mounted in the rotor assembly accommodating cavity 110, the magnet 320 is arranged between the rotor body 310 and the induction circuit board 200, and the magnet 320 is fixedly mounted at one end of the rotor body 310.

The shape of the magnet 320 can be rectangular, circular, etc. It should be noted that this is only an example and the shape of the magnet 320 is not limited.

Exemplarily, the rotor body 310 and the magnet 320 are primary components of the rotor assembly 300. The rotor assembly 300 cooperates with the induction circuit board 200 to generate corresponding electrical signals during the rotation of the rotor body 310, thereby realizing the sensing measurement of angle displacement.

In some embodiments, the angle displacement sensing device provides a rotor assembly accommodating cavity 110 on the main housing body 100, which directly mounts the rotor body 310 in a rotatable manner within the rotor assembly accommodating cavity 110. The matching and mounting method between the rotor body 310 and the rotor assembly accommodating cavity 110 is simple and convenient. Additionally, the magnet 320 is arranged between the rotor body 310 and the induction circuit board 200, and the magnet 320 is fixedly mounted at the end of the rotor body 310 near the induction circuit board 200. This simplifies the mounting structure and reduces production costs without affecting the measurement accuracy of the rotor assembly 300. Therefore, the angle displacement sensing device can achieve the technical effects of simplifying design and reducing costs.

Exemplarily, the rotor assembly 300 further includes an elastic component 330, one end of the elastic component 330 is fixedly connected to the rotor assembly accommodating cavity 110, and another end of the elastic component 330 is fixedly connected to the rotor body 310.

Exemplarily, during the rotation of the rotor body 310, the elastic component 330 switches between its natural state and stretched state, and the rotor body 310 can return to its initial position under the action of the elastic component 330.

Exemplarily, the elastic component 330 is a spring mechanism, the spring mechanism is sleeved on an outer side of the rotor body 310, one end of the spring mechanism is fixedly connected to the rotor assembly accommodating cavity 110, and another end of the spring mechanism is fixedly connected to the rotor body 310.

Exemplarily, the spring mechanism is a torsion spring. The two ends of the torsion spring are fixed to the rotor assembly accommodating cavity 110 and the rotor body 310, respectively. When the rotor body 310 rotates around the center of the torsion spring, the torsion spring generates torque or rotational force, forcing the rotor body 310 to return to its initial position. The torsion spring can store and release angular energy or statically fix the rotor body 310 through rotational force arms along the central axis of the spring.

Exemplarily, the main housing body 100 includes a top housing 120 and a bottom housing 130, the top housing 120 is provided with the rotor assembly accommodating cavity 110, and the bottom housing 130 is matched and mounted with the top housing 120. The bottom housing 130 is provided with corresponding metal terminals 140, and the metal terminals 140 are electrically connected to the induction circuit board 200.

Exemplarily, the electrical connection between the metal terminals 140 and the induction circuit board 200 transmits the electrical signals of the induction circuit board 200 to other devices, thereby realizing the output of angle displacement sensing signals.

Exemplarily, the top housing 120 or bottom housing 130 is provided with an optional shielding cover 160. The shielding cover 160 is metal part, which prevent the inference of magnetic field by environment.

Exemplarily, the angle displacement sensing device further includes a first sealing component 150, and the bottom housing 130 and the top housing 120 are sealed through the first sealing component 150.

Exemplarily, the first sealing component 150 seals the bottom housing 130 and the top housing 120, thereby preventing the shielding cover 160 and metal terminals 140 from being excessive contact with the air and providing an effective anti-rust effect for the shielding cover 160 and metal terminals 140.

Exemplarily, the rotor assembly 300 further includes a rotor cover 340, wherein the rotor cover 340 is mounted to cover the rotor assembly accommodating cavity 110.

Exemplarily, the rotor cover 340 is mounted to cover the rotor assembly accommodating cavity 110, thereby sealing the rotor assembly 300 within the space of the rotor cover 340 and the rotor assembly accommodating cavity 110. This protects the magnet 320 and the elastic component 330 from external contact, achieving waterproof, dustproof, and rustproof effects. It effectively extends the service life of the magnet 320 and the elastic component 330, thereby prolonging the service life of the angle displacement sensing device.

Exemplarily, the rotor assembly 300 includes a second sealing component, wherein the rotor cover 340 is sealed and mounted to the rotor assembly accommodating cavity 110 through the second sealing component.

Optionally, the second sealing component can be a sealing ring.

In some embodiments, the sealing between the rotor cover 340 and the rotor assembly accommodating cavity 110 can adopt methods such as oiling, waxing, ultrasonic welding, in addition to the sealing ring. This is merely exemplary and not limiting, meaning that the sealing between the rotor cover 340 and the rotor assembly accommodating cavity 110 can adopt other types of sealing methods as needed.

Exemplarily, the present disclosure provides a measurement system, including the angle displacement sensing device as shown in FIGS. 1 to 3.

In some embodiments, the interior of the main housing body 100 is provided with a shielding cover 160, and the shielding cover 160 matches the bottom housing 130 or the top housing 120. This arrangement can prevent the shielding cover 160 and metal terminals 140 from being excessive contact with the air and providing an effective anti-rust effect for the shielding cover 160 and metal terminals 140. The bottom housing 130 or the top housing 120 are provided with the shielding cover 160 to increase the convenience of assembly.

In some embodiments, the main housing body 100 and the rotor assembly accommodating cavity 110 are sealed, and the rotor assembly accommodating cavity 110 and the rotor rear cover 340 are also sealed. The sealing methods can include sealing rings, oiling, waxing, ultrasonic welding, and other methods, which are merely exemplary and not limiting.

The sealing between the main housing body 100 and the rotor assembly accommodating cavity 110 can more effectively achieve waterproof and dustproof effects, enabling the angle displacement sensing device to achieve a protection level of IP67 or higher.

The sealing between the rotor assembly accommodating cavity 110 and the rear cover 340 can protect the magnet 320 and the elastic component 330 from external contact, achieving waterproof, dustproof, and rustproof effects. It effectively extends the service life of the magnet 320 and the elastic component 330, thereby prolonging the service life of the angle displacement sensing device.

Exemplarily, the angle displacement sensing device shown in FIGS. 1 to 4 is a non-contact angle displacement sensor.

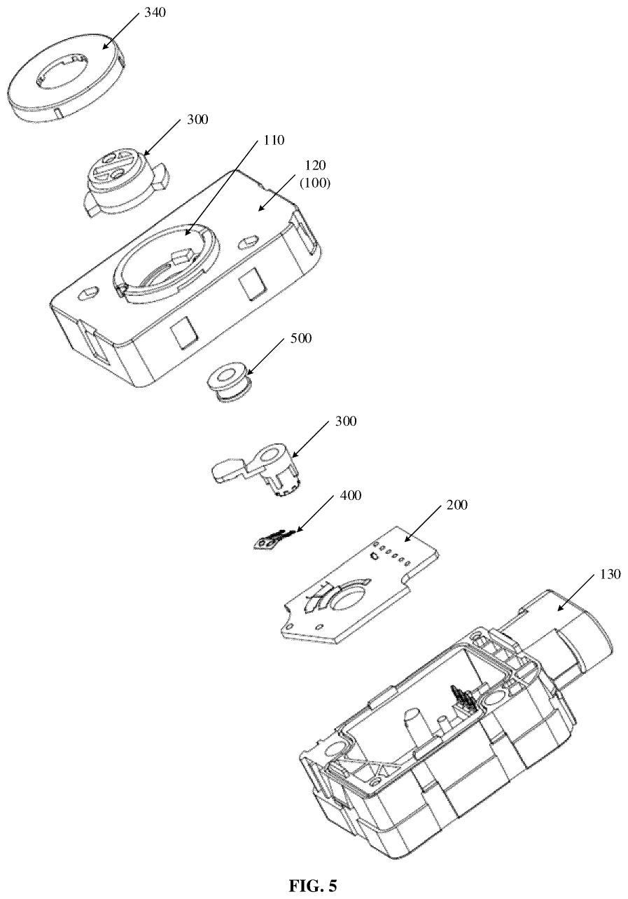

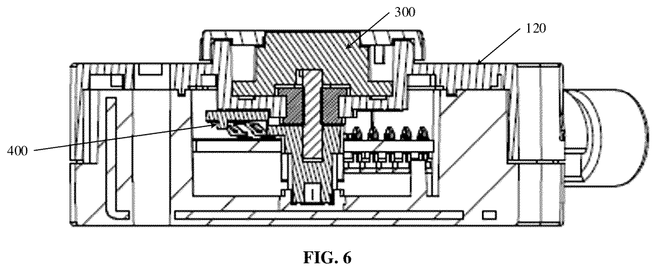

Referring to FIGS. 5 and 6, FIG. 5 is an exploded structural schematic diagram of a second angle displacement sensing device provided in the embodiment of the present disclosure; and FIG. 6 is a sectional structural schematic diagram of a second angle displacement sensing device provided in the embodiment of the present disclosure. FIG. 5 and FIG. 6 show a contact-type angle displacement sensing device. The angle displacement sensing device includes a main housing body 100, an induction circuit board 200, a metal brush 400, and a rotor assembly 300.

Exemplarily, the main housing body 100 is provided with a rotor assembly accommodating cavity 110, and the main housing body 100 is arranged with a metal terminal.

The induction circuit board 200 is arranged inside the main housing body 100.

Exemplarily, the rotor assembly 300 is rotatably arranged in the rotor assembly accommodating cavity 110 of the main housing body 100, the metal brush 400 is fixedly mounted on the rotor assembly 300, and the metal brush 400 is electrically connected to the induction circuit board 200. The metal brush generates a corresponding electrical signal according to the rotation angle of the rotor assembly 300.

The main housing body 100 comprises a top housing, wherein the top housing is of a hollow structure and penetrated by the rotor assembly 300, wherein a sealing ring 500 is connected to a middle of the rotor assembly 300 to separate into an upper space and a lower space to achieve the waterproof and dustproof.

The angle displacement sensing device shown in FIGS. 5 and 6 is a contact-type angular sensor, distinguished from the non-contact angular sensor shown in FIGS. 1 to 4.

In some embodiments, the angle displacement sensing device shown in FIGS. 5 and 6 further includes a sealing ring 500, wherein the sealing ring 500 is mounted on the rotor assembly 300. Optionally, the rotor cover 340 is mounted to cover the rotor assembly accommodating cavity 110.

In all embodiments of the present disclosure, terms such as “big” and “small” are relative terms, “more” and “less” are relative terms, and “up” and “down” are relative terms. Descriptions of such relative terms will not be redundantly elaborated in the embodiments of the present disclosure.

It should be understood that references to “in the embodiment,” “in the embodiment of the present disclosure,” or “as an optional embodiment” throughout the specification indicate that a specific feature, structure, or characteristic described in connection with the embodiment is included in at least one embodiment of the present disclosure. Therefore, the phrases “in the embodiment,” “in an embodiment of the present disclosure,” or “as an optional embodiment” appearing in various parts of the specification do not necessarily refer to the same embodiment. Additionally, these specific features, structures, or characteristics may be combined in any suitable manner in one or more embodiments. A person skilled in the art should also understand that the embodiments described in the specification are all optional embodiments, and the actions and modules involved are not necessarily essential to the present disclosure.

In various embodiments of the present disclosure, it should be understood that the numerical sequence of the processes mentioned above does not imply a mandatory execution order. The execution order of the processes should be determined based on their functions and intrinsic logic and should not impose any limitation on the implementation process of the embodiments of the present disclosure.

The above are only specific embodiments of the present disclosure, but the scope of protection of the present disclosure is not limited thereto. Any person skilled in the art can easily envisage changes or substitutions within the technical scope disclosed in the present disclosure, which should be encompassed within the scope of protection of the present disclosure. Therefore, the scope of protection of the present disclosure shall be subject to the scope of the claims.

What is claimed is:

1. An angle displacement sensing device, comprising a main housing body, an induction circuit board, and a rotor assembly;
the main housing body is provided with a rotor assembly accommodating cavity, and the induction circuit board is arranged inside the main housing body; and
the rotor assembly comprises a rotor body and a magnet, the rotor body is rotatably mounted in the rotor assembly accommodating cavity, the magnet is arranged between the rotor body and the induction circuit board, and the magnet is fixedly mounted at one end of the rotor body.

2. The angle displacement sensing device according to claim 1, wherein the rotor assembly further comprises an elastic component, one end of the elastic component is fixedly connected to the rotor assembly accommodating cavity, and another end of the elastic component is fixedly connected to the rotor body.

3. The angle displacement sensing device according to claim 2, wherein the elastic component is a spring mechanism, the spring mechanism is sleeved on an outer side of the rotor body, one end of the spring mechanism is fixedly connected to the rotor assembly accommodating cavity, and another end of the spring mechanism is fixedly connected to the rotor body.

4. The angle displacement sensing device according to claim 3, wherein the spring mechanism is a torsion spring.

5. The angle displacement sensing device according to claim 1, wherein the main housing body comprises a top housing and a bottom housing, the top housing is provided with the rotor assembly accommodating cavity, and the bottom housing is matched and mounted with the top housing, the bottom housing is provided with corresponding metal terminals, and the metal terminals are electrically connected to the induction circuit board.

6. The angle displacement sensing device according to claim 5, wherein the top housing or the bottom housing is provided with a shielding cover, wherein the shielding cover is metal part preventing inference of magnetic field by environment.

7. The angle displacement sensing device according to claim 5, wherein the angle displacement sensing device further comprises a first sealing component, and the bottom housing and the top housing are sealed through the first sealing component.

8. An angle displacement sensing device, comprising a main housing body, an induction circuit board, a metal brush, and a rotor assembly;
the main housing body is provided with a rotor assembly accommodating cavity, and the main housing body is arranged with a metal terminal;
the induction circuit board is arranged inside the main housing body; and
the rotor assembly is rotatably arranged in the rotor assembly accommodating cavity of the main housing body, the metal brush is fixedly mounted on the rotor assembly, and the metal brush is electrically connected to the induction circuit board.

9. A measurement system, comprising the angle displacement sensing device according to claim 1.

10. The angle displacement sensing device according to claim 6, wherein the angle displacement sensing device further comprises a first sealing component, and the bottom housing and the top housing are sealed through the first sealing component.

11. The measurement system according to claim 9, wherein the rotor assembly further comprises an elastic component, one end of the elastic component is fixedly connected to the rotor assembly accommodating cavity, and another end of the elastic component is fixedly connected to the rotor body.

12. The measurement system according to claim 11, wherein the elastic component is a spring mechanism, the spring mechanism is sleeved on an outer side of the rotor body, one end of the spring mechanism is fixedly connected to the rotor assembly accommodating cavity, and another end of the spring mechanism is fixedly connected to the rotor body.

13. The measurement system according to claim 12, wherein the spring mechanism is a torsion spring.

14. The measurement system according to claim 9, wherein the main housing body comprises a top housing and a bottom housing, the top housing is provided with the rotor assembly accommodating cavity, and the bottom housing is matched and mounted with the top housing, the bottom housing is provided with corresponding metal terminals, and the metal terminals are electrically connected to the induction circuit board.

15. The measurement system according to claim 14, wherein the top housing or the bottom housing is provided with a shielding cover, wherein the shielding cover is metal part preventing inference of magnetic field by environment.

16. The measurement system according to claim 14, wherein the angle displacement sensing device further comprises a first sealing component, and the bottom housing and the top housing are sealed through the first sealing component.

17. The angle displacement sensing device according to claim 8, wherein the rotor assembly further comprises a rotor cover and a second sealing component, the rotor cover is mounted to cover the rotor assembly accommodating cavity, and the rotor cover is sealed and mounted to the rotor assembly accommodating cavity through the second sealing component.

18. The angle displacement sensing device according to claim 17, wherein the main housing body comprises a top housing, wherein the top housing is of a hollow structure and penetrated by the rotor assembly, wherein the second sealing component is connected to a middle of the rotor assembly to separate into an upper space and a lower space.

19. The angle displacement sensing device according to claim 18, wherein the second sealing component is a sealing ring.
